(19) United States
(12) Patent Application Publication
(10) Pub. No.: US 2024/0401878 A1
(43) Pub. Date: Dec. 5, 2024

(54) ZERO FLARING DURING NGL RECOVERY PLANT DRYING OUT

(71) Applicant: SAUDI ARABIAN OIL COMPANY, Dhahran (SA)

(72) Inventors: Mohammed Jassim Alkhamis, Udhailiyah (SA); Hamad Abdullah Alkhaldi, AlAhsa (SA)

(73) Assignee: SAUDI ARABIAN OIL COMPANY, Dhahran (SA)

(21) Appl. No.: 18/326,916

(22) Filed: May 31, 2023

(51) Int. Cl. F25J 3/02

(52) U.S. Cl. CPC F25J 3/0295; F25J 3/0209; F25J 2220/68; F25J 2280/10

(57) ABSTRACT

Methods and systems for startup of a natural gas liquids plant without flaring.

### BACKGROUND

Hydrate formation is undesirable in natural gas processing facilities. It is typical for natural gas liquids (NGL) recovery trains during start up to undergo dry out activity to remove moisture from the system. The moisture is typically left in equipment after construction, shutdown, or maintenance procedures, such as by completion of hydro testing or other maintenance activities that may introduce water, moisture, or ambient humidity into the various equipment. The normal practice is to send this drying gas to flare after passing through the unit to remove the moisture in the system as part of the start-up procedure.

Drying out of the process equipment may take several weeks to complete. For example, depending on the facility size, location, and other factors, drying out could take 21 to 30 days for initial startup, and 5-10 days following maintenance. Flaring of the drying gas can thus result in combustion of a significant amount of natural gas, possibly hundreds of millions of standard cubic feet of natural gas, consuming valuable product and producing a significant quantity of carbon dioxide greenhouse gas emissions.

### SUMMARY

Embodiments herein are directed toward systems and processes for drying of a natural gas plant. More particularly embodiments herein are directed toward drying of a natural gas plant without flaring of natural gas during the drying process.

In one aspect, embodiments disclosed herein relate to methods and systems for startup of a natural gas plant. A quantity of natural gas feed is dehydrated in a dehydration unit to fully inventory a natural gas liquids recovery plant with a quantity of a dehydrated natural gas. The quantity of dehydrated natural gas is then cyclically circulated to remove moisture from the natural gas liquids recovery plant. The circulating includes recovering a wet natural gas from the natural gas liquid recovery plant, then compressing, with a sales gas compressor, the wet natural gas and transporting the compressed wet natural gas to the dehydration unit. In the dehydration unit, the compressed wet natural gas is dehydrated to recover a dried natural gas, which is then fed through the natural gas liquids recovery plant to absorb additional moisture. The circulating continues, repeating the recovering, compressing, drying, and feeding, until a measured moisture content in the compressed wet natural gas is less than 0.1 ppmv. When a moisture content in the compressed wet natural gas is less than 0.1 ppmv, operating conditions in the natural gas liquids recovery plant are transitioned to produce product streams, including a sales gas and natural gas liquids, the sales gas being compressed by the sales gas compressor and fed downstream. By use of methods and systems herein, startup of the natural gas plant may be performed without the need for flaring during startup.

Other aspects and advantages of the claimed subject matter will be apparent from the following description and the appended claims.

### BRIEF DESCRIPTION OF DRAWINGS

FIG. 1 is a simplified block process flow diagram of a natural gas system having improved start up features according to embodiments herein.

FIG. 2 is a simplified process flow diagram of a natural gas system having improved start up features according to embodiments herein.

### DETAILED DESCRIPTION

Embodiments disclosed herein relate to systems and configurations of a natural gas plant that provide for drying of the natural gas plant without the need for flaring of wet natural gas.

Natural gas plants according to embodiments herein may include a dehydration unit and a separation unit. The dehydration unit is used, during normal operations, to dehydrate a feed natural gas, removing water to a low enough level to avoid hydrate formation during the cryogenic processing in the separation unit. The separation unit is used, during normal operations, to separate the feed natural gas into hydrocarbon product streams, which may include a methane-rich sales gas stream, and one or more heavier hydrocarbon streams that may include ethane, propane, and possibly butane.

Various configurations for separation of the natural gas into a sales gas and a natural gas liquids product may be used. Some separation units may include a single column system, while others may include two or more columns, such as a two-column separation scheme, for example. A feed natural gas stream may be supplied at a pressure in a range from 48 bar to 103.4 bar (700 to 1500 psia), dried in the dehydration unit, and then fed to the separation unit. In the separation unit, the dried feed gas may be expanded, such as to pressures in the range of 10 bar to 31 bar (150 to 450 psia) for separation of the various hydrocarbon compounds in one or more separation columns or absorbers, and to provide refrigeration for cooling of various streams during the separation process.

A methane-rich gas stream may be recovered from an overhead of the single separation column or from an overhead of a De-methanizer in a multiple column configuration. A bottoms fraction from a single column system may be lean in methane, and may include ethane or ethane and propane, for example, and may be recovered as a natural gas liquids stream. The overhead stream recovered may then be compressed to pipeline sales gas specifications, such as to 69 bar (1000 psia) or above.

Compression of the overhead stream may be conducted, in some embodiments, using one or multiple compressors, referred to herein as a “sales gas compressor.” The sales gas compressor pressurizes the sales gas to pipeline pressures, and an aftercooler may be used to ensure the temperature of the natural gas being fed to the pipeline is at or below a specified pipeline supply temperature.

The refrigeration and separations as generically outlined above result in extremely low process temperatures, such as −101° C. (−150° F.) or colder. Thus, prior to use during normal operations, the system components (pipes, heat exchangers, tanks, columns, etc.) and the feed must be sufficiently dry to avoid hydrate formation.

Embodiments herein are directed toward systems and processes for drying of the system components, such as during initial startup following construction, as well as for startups following shutdown periods, such as for maintenance operations. The drying procedures and systems herein may be used to reliably and repeatably remove moisture from the system components, providing for hydrate-free startup of the natural gas plant.

Drying out of the natural gas plant may begin with filling or inventorying the natural gas liquids recovery plant with natural gas. A natural gas feed is dried in the dehydration unit to recover dehydrated natural gas, which is then used to inventory the natural gas liquids recovery plant with a quantity of the dehydrated natural gas. Following inventorying of the natural gas plant, the feed of natural gas may be stopped. The quantity of dehydrated natural gas may then be circulated (re-circulated) through the system to remove moisture from the natural gas liquids recovery plant.

The circulating process includes recovering wet natural gas from the natural gas liquids recovery plant. The wet natural gas may be recovered, for example, from an overhead of the separation column feeding the sales gas compressor. During the drying process, rather than forwarding the overheads gas from the sales gas compressor to the product pipeline (sales gas sent outside the boundary limits of the plant), the sales gas compressor may feed the wet gas to the drying unit.

The wet natural gas may be compressed and transported via a recirculation line fluidly connecting from downstream of the sales gas compressor to upstream of the drying system. In the drying system (dehydration unit), the compressed wet natural gas may be dehydrated to recover a dried natural gas. The dried natural gas is then fed from the drying system through the natural gas liquids recovery plant to absorb additional moisture, producing a wet natural gas again circulated (re-circulated) by the sales gas compressor back to the drying system.

In this manner, recirculating the inventoried natural gas, repeating the above outlined steps (recovering a wet natural gas, compressing with the sales gas compressor, drying in the drying system, feeding through the separation system), a single inventory of natural gas may be used to remove moisture from the system. The moisture is effectively removed by the drying system, which is normally used for drying of the feed, and the natural gas may be circulated by the sales gas compressor, which is normally used to compress sales gas to pipeline specifications.

During the circulation of the natural gas during the drying process, a moisture content of the wet natural gas (feed to the sales gas compressor) or the compressed wet natural gas (discharge of the sales gas compressor) may be measured, continuously or periodically. To prevent hydrate formation, the drying process may be continued until the moisture content in the wet or compressed wet natural gas is less than 0.1 ppmv.

When the unit is sufficiently dry, such as when a moisture content in the compressed wet natural gas is less than 0.1 ppmv, the operating conditions in the natural gas liquids recovery plant may be transitioned to produce a sales gas and natural gas liquids, the sales gas being compressed by the sales gas compressor and fed to a pipeline as a natural gas product stream (sales gas).

For the above-described drying process, the quantity of natural gas inventoried should be sufficient to fill the pipes and unit operations (columns, separators, heat exchangers, etc.) with natural gas to provide during circulation a desired feed pressure (inlet to drying system) so as to effectively flow natural gas through all portions of the system, including columns, separators, heat exchangers, pipes, etc. The inventoried natural gas should also be of a sufficient quantity to provide sufficient feed pressure to the sales gas compressor to achieve the desired circulation throughout the system. In some embodiments, for example, the sales gas compressor may have a lower design limit for inlet pressure, and the inventoried natural gas should provide at least the specified lower design limit inlet pressure. While the design limits may vary, embodiments herein contemplate that an inlet feed pressure of the wet natural gas fed to the sales gas compressor during the circulation drying process may be in a range from 10.3 bar to 31 bar, such as from 17.2 bar to 31 bar, or from 20.6 bar to 31 bar (in a range from 150 psia to 450 psia, such as from 250 to 350 psia or from 300 psia to 350 psia).

The normal practice of prior art startup procedures is to send the drying gas to a flare system after passing through the unit to remove the moisture in the system. In contrast, embodiments herein target recirculation of the natural gas used for drying, achieving zero flaring during the dry out step of the unit start up process. Embodiments herein thus include, as a system component, piping and valving to provide for the recirculation of drying gas from the product output to the feed input. Systems herein may thus provide for the natural gas liquids plant to be dried out during start up using an inventory of dry gas and without flaring any gas. This optimized drying out step is achieved by flowing gas through the unit, where moisture is picked up from the equipment and is saturated. The wet gas is then compressed through the sales gas compressors and recycled to the inlet of the plant. The wet compressed gas then passes through the drying system, which may include coalescers and molecular sieves beds, which will remove any free liquid or moisture before the recirculating drying gas is again directed to the NGL recovery train equipment. The drying process continues with this recycling of gas until the target moisture level of 0.1 ppmv is achieved.

In some embodiments, the sales gas compressor has a fixed head motor. The pressure of the recirculating gas may be maintained at minimum of 22.1 barg (320 psig) in such embodiments, enabling the compressor to operate properly, compressing the wet gas in the fixed head motor driven sales gas compressors.

In some embodiments, the dry out gas temperature can be increased to help in removing the moisture and increase capability of the recirculating gas to remove moisture. The temperature can be increased, for example, to a temperature in the range from about 37.7° C. to 93.3° C. (100° F. up to about 200° F.). As a result, the unit will operate with gas but with complete recycle where the gas is compressed through the compressor and going back to the inlet of the unit. The moisture is captured in the gas and removed in the gas dehydrators. After that, regen gas can be used to remove moisture from the bed during the regeneration activity. The regen gas is cooled through existing fin fan coolers where moisture is converted to liquid water and captured in knock-out drum. The water is sent outside of the plant for recovery and further water stripping process.

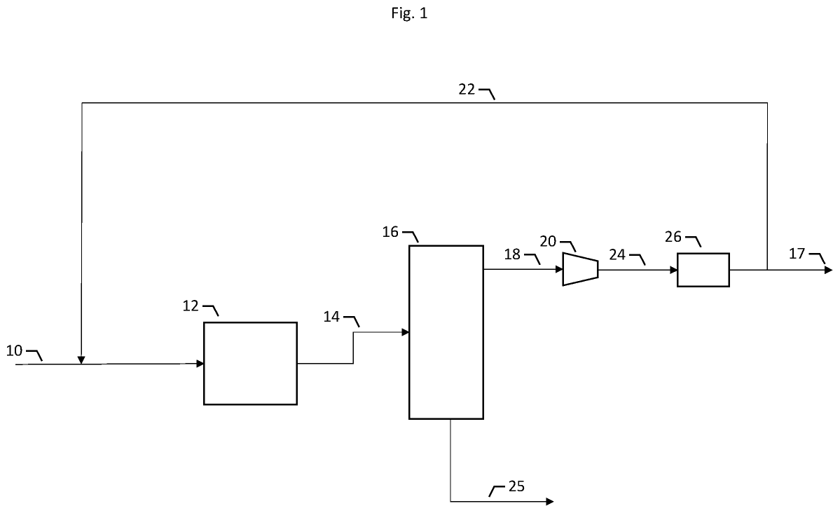

Referring now to FIG. 1, a simplified block process flow diagram of systems according to embodiments herein is illustrated. A natural gas feed 10 may be provided to dryer system 12 from upstream processing (not illustrated). Upstream processing may include, for example, separation of the natural gas from other produced fluids, particulate removal, liquid separations, acid gas removal, and other upstream processes associated with production of the natural gas. Following drying, the dried natural gas feed 14 is fed to the separation system 16.

Prior to conducting normal natural gas processing operations, startup of the separation system may include a drying out process. During the drying out process, the natural gas feed 10 is dried in dryer system 12 and the dried natural gas 14 is fed to fully inventory separation system 16. The flow of natural gas feed 10 may then be stopped. Within the separation system, the dried natural gas will pick up moisture from the system components. A wet natural gas stream 18 is withdrawn from separation system 16, compressed in sales gas compressor 20 and circulated back to drying system 12 via flow line 22.

The drying out process is continued by circulating wet natural gas 22 from sales gas compressor 20 to drying system 12, where the moisture picked up from within separation system 16 is removed from the circulating natural gas. The dried circulating natural gas then passes through the separation system 16 again, picking up additional moisture to be removed in the drying system 12 during the cyclic drying process. In this manner, the inventoried natural gas may be used to dry out the separation system components to remove moisture, and once moisture is removed to adequate levels, the system may be transitioned to normal operating conditions.

During the drying out process, the compressed wet gas 24 discharged from sales gas compressor 20 may be cooled in an aftercooler 26. In some embodiments, aftercooler 26 may be bypassed or may be non-operational (fans of a fin-fan cooler being turned off, for example). In this manner, the compression of the circulating gas may introduce a quantity of heat, which may carry through to the separation system. A quantity of heat may also be introduced via regeneration gas heaters (not illustrated) within the drying system 12. The heat introduced to the circulating natural gas may aid in moisture removal, increasing water solubility in the circulating natural gas.

During normal operations, following drying of the natural gas, operating conditions may be transitioned to perform the desired separations within the separation system 16, and flow of feed gas 10 may be resumed. Dried natural gas 14 may be forwarded into the separation system 16 for separation of the natural gas into a methane rich sales gas 18 and one or more liquid natural gas streams 25, which may include ethane and propane, for example. As noted above, the separation system may include a single separation column or multiple separation columns, along with heat exchange and refrigeration (closed loop or open loop). The methane-rich sales gas is recovered from the separation system via flow line 18 and forwarded for compression and cooling to pipeline specifications. The compression and cooling may be performed, for example, using one or more compressors, including sales gas compressor 20, and may be cooled using one or more compressor inter-stage coolers (not illustrated) and an aftercooler 26, producing a cooled and compressed sales gas stream 17 for export.

To facilitate the drying process according to embodiments herein, one or more flow lines are provided to circulate natural gas from the sales gas compressor to upstream of the drying system. As illustrated in FIG. 1, flow line 22 provides for circulation of the drying gas through the drying system 12 and separation system 16 back to the sales gas compressor 20. In this manner, a dry natural gas, provided from the drying system to inventory the separation system, may be circulated to perform the drying out process, accumulating moisture from the separation system components, removing the moisture in the drying system, and again forwarding the circulating natural gas through the separation system to remove additional moisture.

Circulation of the wet natural gas from the sales gas compressor through the drying system has been found to remove moisture adequately and efficiently from the overall separation system to avoid hydrate formation. If desired, however, recirculation of other typical product streams, such as a recirculation line provided to circulate natural gas from an ethane-rich liquid natural gas product stream, such as stream 25, back through the drying system during the drying out process is also contemplated.

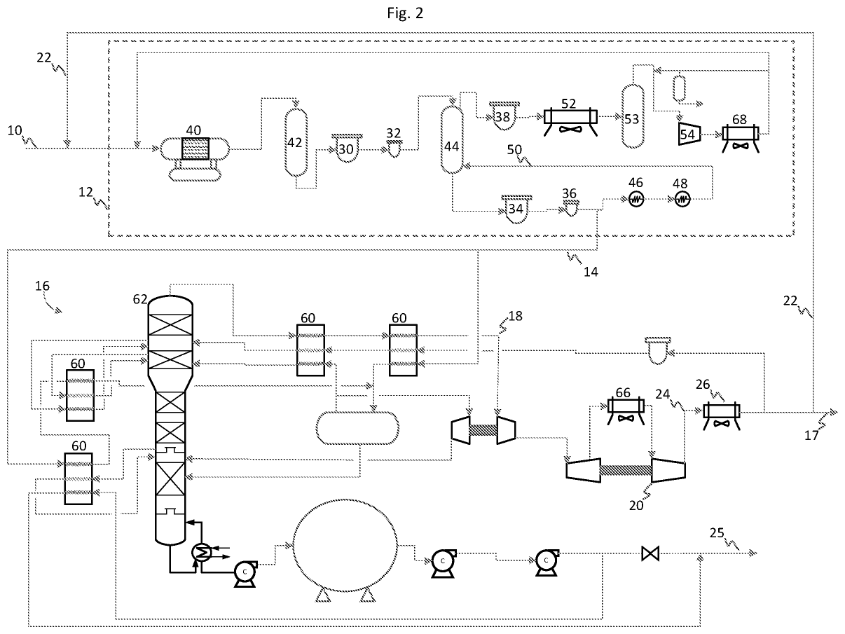

Referring now to FIG. 2, a simplified process flow diagram of systems according to embodiments herein is illustrated, where like reference numerals represent like parts. While embodiments of drying out processes herein may be used for other various natural gas plant designs, FIG. 2 provide a more specific example of the integration of the separation system product streams and the drying system to provide the benefits of zero flaring, reduced greenhouse gas emissions, and other benefits during system startups as noted herein.

While upstream processing may include liquids separation, the natural gas plant as illustrated in FIG. 2 includes a drying system 12 configured to remove water in feed natural gas 10 down to extremely low levels to avoid hydrate formation, as well as to accommodate any slugs of water that may be introduced by upstream upsets. Drying system 12 may include filters (30, 32, 34, 36, 38), coalescers (40), contaminant removal beds, such as a bed 42 to remove mercury, and molecular sieve dehydration beds 44, for example. Feed natural gas 10 may pass through the coalescer to remove any bulk water droplets, then through mercury removal bed 42, and molecular sieve dehydration bed 44, producing a dried natural gas stream 14.

Dryer systems according to embodiments herein may include multiple molecular sieve dryer beds 44, and may be operated in parallel with one or more beds in drying mode and one or more beds in regeneration mode. For the regeneration of the molecular sieve beds, a heater system 46, 48 may be provided to heat a portion of the dried natural gas 14, provided to the beds 44 in drying mode as a regeneration gas 50. The drying gas may pick up moisture from the molecular sieves being regenerated, and then the drying gas may be cooled in a heat exchanger 52 to remove water from the regenerating gas, the water being recovered from knock out drum 53. The cooled regenerating gas may then be pressurized using a compressor 54, and the compressed drying gas may be recirculated to the inlet of the drying system for continued processing of the natural gas.

Similar to the embodiment of FIG. 1, the dried natural gas 14 may be fed to separation system 16 for separation of the heavier, condensable hydrocarbons, recovered by stream 25, from the lighter, non-condensable gases, recovered as a methane rich sales gas 17. While the flow lines are not described step by step, separation system 16 may include one or multiple heat exchangers or “cold boxes” 60 for exchanging heat between any number of streams. The dried natural gas 14 may be divided into multiple portions and expanded to provide refrigeration. Similarly, product streams, such as the sales gas or the natural gas liquids, may be used to provide cooling and/or heating to achieve the desired separations within De-methanizer 62. De-methanizer 62 overheads fraction 64 may be used to provide cooling in one or more cold boxes 60 and may then be compressed in one or more compression stages to produce a compressed and cooled sales gas 17.

To facilitate the drying process according to embodiments herein for the system as illustrated in FIG. 2, one or more flow lines are provided to circulate natural gas from the sales gas compressor to upstream of the drying system. As illustrated in FIG. 2, flow line 22 provides for circulation of the drying gas through the drying system 12 and separation system 16 back to the sales gas compressor 20. Alternatively, if no free water is anticipated, the circulation of wet gas from the sales gas compressor may be returned to the drying system upstream of the molecular sieve bed 44. In this manner, a dry natural gas, provided from the drying system to inventory the separation system, may be circulated to perform the drying out process, accumulating moisture from the separation system components, removing the accumulated moisture in the drying system, and again forwarding the circulating natural gas through the separation system to remove additional moisture.

During the drying out process, the pressure provided by sales gas compressor 20 may be used to circulate natural gas throughout the components of the separation system to remove moisture therein. While not illustrated, valving, controls, and other equipment utilized during normal operation of the separation system may be used during the drying out process to provide for flow of the inventoried natural gas throughout all portions of the system, or at a minimum through the portions of the system that require moisture removal to avoid freezing of pipes and/or hydrate formation.

In some embodiments, such as where it is desired to circulate drying gas at a slightly elevated temperature, sales gas compressor intercooler 66 and sales gas compressor aftercooler 26 may be bypassed, run at reduced cooling capacity, or non-operational. Similarly, drying gas compressor 54 aftercooler 68 may be bypassed, run at reduced cooling capacity, or non-operational, allowing additional heat to accumulate within the circulating drying gas.

As an example of increasing the circulating drying gas temperature, the compressed gas out of the sales gas compressor will have a higher temperature due to the work input of compression, as thus the sales gas compressor is equipped with aftercoolers to cool down the gas to meet pipeline specification during normal operations. The temperature of the compressed gas from the sales gas compressor can reach as high as 110° C. (230° F.), for example. Thus, to provide a higher circulating drying gas temperature, the number of aftercooler fin fans operated can be reduced to increase the temperature of the circulating drying gas, such as by cooling the circulating drying gas to 82° C. to 93° C. (180-200° F.) instead of the normal pipeline temperature target of less than 60° C. (less than 140° F.), such as a temperature in a range from 50° C. to 60° (120° F. to 140° F.).

After achieving the target dryout specification for 0.1 ppmv moisture content at cryogenic sections, then the dryout step can be concluded. The unit feed gas valves at line 10 can be fully opened. Following that, a recycle valve on stream 22 can start to be gradually closed to ensure smooth transition of the unit operation to switch from recycle mode to normal operation mode, producing a sales gas product.

The above-described drying process will eliminate flaring during the commissioning of a plant as well as during start-ups following shutdowns and maintenance. Achieving the dry out using embodiments herein will have a positive impact on the environment by eliminating the flaring and carbon dioxide emissions. Moreover, there will be energy saving out of the volume of gas that is prevented from daily flaring and saving the master gas system from shortage.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method for startup of a natural gas liquids plant, the method comprising:
dehydrating a natural gas feed in a dehydration unit to recover a dehydrated natural gas;
inventorying a natural gas liquids recovery plant with a quantity of the dehydrated natural gas;
circulating the quantity of the dehydrated natural gas to remove moisture from the natural gas liquids recovery plant, the circulating comprising:
recovering a wet natural gas from the natural gas liquid recovery plant;
compressing, with a sales gas compressor, the wet natural gas and transporting the compressed wet natural gas to the dehydration unit;
dehydrating, in the dehydration unit, the compressed wet natural gas to recover a dried natural gas;
feeding the dried natural gas through the natural gas liquids recovery plant to absorb additional moisture;
measuring a moisture content of the compressed wet natural gas; and
repeating the recovering, compressing, drying, feeding, and measuring until a moisture content in the compressed wet natural gas is less than 0.1 ppmv; and
when a moisture content in the compressed wet natural gas is less than 0.1 ppmv, transitioning operating conditions in the natural gas liquids recovery plant to produce a sales gas and natural gas liquids, the sales gas being compressed by the sales gas compressor and fed downstream.

2. The method of claim 1, further comprising maintaining, during the circulating, a pressure of the wet natural gas at an inlet of the sales gas compressor at a pressure greater than 22 bar (greater than 320 psig).

3. The method of claim 1, further comprising heating the dried natural gas circulating to a temperature in a range from 37.7° C. to 93.3° C. (100° F. to 200° F.).

4. The method of claim 1, wherein the circulating is conducted without flaring of wet natural gas.

5. The method of claim 1, wherein the natural gas liquid recovery plant comprises one or multiple separation columns or absorbers and multiple heat exchange units, a separation column producing an overhead gas fed to the sales gas compressor, the sales gas compressor compressing the overhead gas to produce a compressed overhead gas, and one or more sales gas compressor aftercoolers for cooling the compressed overhead gas, the process comprising:
during the circulating, cooling the compressed overhead gas in the sales gas compressor aftercoolers to a temperature in a range from 82° C. to 93° C. (180-200° F.);
wherein the transitioning comprises cooling the compressed overhead gas in the sales gas compressor aftercoolers to a temperature of less than 60° C. (140° F.).

6. The method of claim 5, wherein the transitioning comprises opening a natural gas feed valve to provide a continuous supply of the natural gas feed, and closing a recycle valve to terminate the circulating of the quantity of dehydrated natural gas.

7. The method of claim 1, wherein the dehydration unit comprises multiple molecular sieve dryer beds operating in parallel, the method further comprising:
operating at least one of the molecular sieve dryer beds in drying mode, dehydrating the compressed wet natural gas to recover the dried natural gas; and
operating at least one of the molecular sieve dryer beds in regeneration mode, regenerating molecular sieves in the molecular sieve dryer bed, wherein the regenerating comprises:
heating a portion of the dried natural gas recovered from operating molecular sieve dryer beds to form a heated regeneration gas;
passing the heated regeneration gas over molecular sieves in regenerating molecular sieve dryer beds to remove moisture from the molecular sieves and to recover a wet regeneration gas;
compressing and cooling the wet regeneration gas to recover water and a dried regeneration gas; and
mixing the dried regeneration gas with the compressed wet natural gas upstream of the dehydration unit.
